(19) United States
(12) Patent Application Publication
(10) Pub. No.: US 2012/0182491 A1
(43) Pub. Date: Jul. 19, 2012

(54) LIQUID CRYSTAL DISPLAY DEVICE

(75) Inventors: Katsuya Ogawa, Osaka-shi (JP); Masakatsu Tominaga, Osaka-shi (JP); Masayuki Takashima, Osaka-shi (JP); Tomoo Furukawa, Osaka-shi (JP)

(73) Assignee: SHARP KABUSHIKI KAISHA, Osaka-shi, Osaka (JP)

(21) Appl. No.: 13/498,329

(22) PCT Filed: May 12, 2010
(86) PCT No.: PCT/JP2010/058055

§ 371 Date: Mar. 27, 2012

(30) Foreign Application Priority Data
Oct. 16, 2009 (JP) 2009-239717

(51) Int. Cl. G02F 1/136

(52) U.S. Cl. 349/43

(57) ABSTRACT

The present invention provides a liquid crystal display device that uniformly stabilizes the alignment direction of liquid crystal molecules, prevents display roughness and what is called an afterimage phenomenon in which a previous display state remains unchanged in switching display, has excellent display performance, and responds to finer pixels. A liquid crystal display device of the present invention comprises: a pair of substrates; and a liquid crystal layer sealed between the pair of substrates, wherein the liquid crystal layer contains liquid crystal molecules that are aligned vertically to a substrate surface when no voltage is applied, at least one of the pair of substrates includes a pixel electrode, a gate bus line, and a source bus line, the pixel electrode is provided with a slit, the slit bends, and a part of the slit is along the gate bus line.

### TECHNICAL FIELD

The present invention relates to a liquid crystal display device. More particularly, it relates to a liquid crystal display device in an MVA (Multi-domain Vertical Alignment) mode.

### BACKGROUND ART

The liquid crystal display device is widely used for electronic apparatuses such as monitors, projectors, cellular phones, and Personal Digital Assistants (PDAs) because it is thin, lightweight, and low in power consumption.

A display type of a liquid crystal display device is determined depending on how liquid crystals are aligned in a cell. Conventionally known display modes of liquid crystal display devices are, for example, a TN (Twisted Nematic) mode, a VA (Vertical Alignment) mode, an IPS (In-Plane Switching) mode, and an OCB (Optically self-Compensated Birefringence) mode.

Liquid crystal display devices with such display modes have been mass produced. Particularly, for example, liquid crystal display devices in a TN mode are widely used by the general public. However, liquid crystal display devices in a TN mode require improvement in terms of increasing the response speed and viewing angle.

In contrast, the VA mode is known in which liquid crystal molecules that are aligned vertically to a substrate surface when no voltage is applied are inclined when a voltage is applied, and thereby display is provided. The VA mode characteristically has a higher contrast than the TN mode, IPS mode, and OCB mode. An MVA liquid crystal display device (hereinafter, also abbreviated as an MVA-LCD) is particularly used in which ribs and slits for electrodes are provided on a substrate as a means for controlling alignment. The MVA mode is a mode for dividing, in multiple directions, the alignment direction of liquid crystal molecules by the means for controlling alignment thus provided on a substrate. In addition, the MVA mode realizes a wide viewing angle by dividing, in multiple directions, the direction in which liquid crystal molecules are inclined when a voltage is applied.

As a liquid crystal display device of such an MVA mode, Patent Document 1, for example, discloses a liquid crystal display device in which a second slit is formed in an edge portion of a pixel electrode between a rib and a slit, and a second rib corresponding to the second slit is formed on a second substrate, whereby the influence on liquid crystal molecules by the electric field from the edge portion of the pixel electrode and the adjacent pixels can be alleviated.

### PRIOR ART REFERENCES

### Patent Document

[Patent Document 1] JP 2007-264673A

### SUMMARY OF THE INVENTION

### Problems to be Solved by the Invention

However, there is room for improvement in that, in liquid crystal display panels, particularly small- and mid-sized high-definition liquid crystal display panels used for mobile devices and the like, the distance between a rib and a slit is short, and it may be difficult to form a second rib and/or second slit between the rib and the slit in terms of size when the configuration of the above-mentioned liquid crystal display device is applied.

The present invention was made in view of the above problems and it is an object of the present invention to provide a liquid crystal display device that uniformly stabilizes the alignment direction of liquid crystal molecules, prevents display roughness and what is called an afterimage phenomenon in which a previous display state remains unchanged in switching display, has excellent display performance, and responds to finer pixels.

### Means for Solving the Problems

The present inventors have investigated various liquid crystal display devices excellent in display performance and noted that, in a liquid crystal display device containing liquid crystal molecules that are aligned vertically to a substrate surface when no voltage is applied, the liquid crystal molecules are less likely to be aligned in a desired direction under the influence of the electric field of a peripheral end of a pixel electrode, and the alignment disorder causes what is called an afterimage phenomenon in which a previous display state remains unchanged in switching display, display roughness, and inferior display performance. They have found that portions along a gate bus line are particularly under the strong influence of a gate electric field, and are subjected to large alignment disorder of liquid crystal molecules, leading to the main cause of deterioration of display performance of the liquid crystal display device. They have also investigated that the design change of the portions suppresses the alignment disorder of liquid crystal, and consequently found that the configuration in which a slit provided in the pixel electrode bends and a part of the slit is along the gate bus line can sufficiently suppress the alignment disorder of the liquid crystal in the portions, and thereby can prevent afterimages and display roughness. Thus, the above-mentioned problems have been admirably solved, leading to completion of the present invention.

That is, the present invention relates to a liquid crystal display device, comprising: a pair of substrates; and a liquid crystal layer sealed between the pair of substrates, wherein the liquid crystal layer contains liquid crystal molecules that are aligned vertically to a substrate surface when no voltage is applied, at least one of the pair of substrates includes a pixel electrode, a gate bus line, and a source bus line, the pixel electrode is provided with a slit, the slit bends, and a part of the slit is along the gate bus line.

Hereinafter, the present invention will be described in detail.

The liquid crystal display device of the present invention is different from the above-mentioned background art in the following two points.

(1) The shape of a slit (pixel electrode slit) is changed. (2) A part of the slit is along a gate bus line.

The liquid crystal display device of the present invention exerts the following effects based on such a configuration. (1) The alignment disorder of liquid crystal along the gate bus line can be sufficiently suppressed, and the above-mentioned afterimages and display roughness can be prevented, leading to excellent display performance. (2) In the liquid crystal display device of the present invention, a second rib and a second slit whose width are respectively smaller than a main rib and the slit may not be provided between the main rib and the slit. In this case, particularly in small- and mid-sized liquid crystal display panels, there is no size problem, leading to easy industrial production.

The expression “a part of the slit is along the gate bus line” means that, when a substrate that includes a pixel electrode, a gate bus line, and a source bus line is seen in the substrate normal direction, a part of the slit in the longitudinal directions is substantially parallel to the gate bus line in the longitudinal direction. The angle formed by these two is, for example, preferably 15° or less, more preferably 10° or less, and further preferably 5° or less. The distance between the part of the slit and the gate bus line is preferably 10 μm or less, more preferably 8 μm or less, and further preferably 5 μm or less. The preferable lower limit thereof is 1 μm or more.

The gate bus line and the source bus line are usually used for driving an active matrix-type liquid crystal display device, and may include other signal wirings such as a storage capacitor bus line.

The pixel electrode is usually provided in each pixel and used for applying a voltage to a liquid crystal layer. The embodiment in which the gate bus line and the source bus line are disposed under the pixel electrode is preferred.

The liquid crystal layer may have a mode in which the liquid crystal layer contains liquid crystal molecules that are aligned vertically to the substrate surface when no voltage is applied, and are aligned horizontally to a substrate surface when a voltage is applied. The expression “aligned vertically to the substrate surface” means that liquid crystal molecules may not be aligned at an angle of 90° to a substrate surface as long as the effects of the present invention are exerted. The display method of the liquid crystal display device using such a liquid crystal layer is referred to as a vertical alignment (VA) mode. The vertical direction may be a substantially vertical direction to such a degree that it is generally evaluated as a vertical alignment (VA) mode in the technical field of the liquid crystal display panel. The liquid crystal display device of the present invention is suitably applicable to a MVA-LCD that includes a rib, as well as a slit, on a substrate, as an alignment regulating structure.

The configuration of the liquid crystal display device of the present invention is not especially limited as long as it essentially includes such components. The liquid crystal display device may or may not include other components.

The following gives a detailed explanation of preferable embodiments of the liquid crystal display device of the present invention.

According to a preferable embodiment of the liquid crystal display device of the present invention, the slit includes a longitudinal portion and an extended portion that extends from an end of the longitudinal portion to a different direction, and the extended portion is along the gate bus line.

The longitudinal portion in the longitudinal direction is longer than the longitudinal portion of the extended portion.

According to such an embodiment, the effects of the present invention can be further exerted.

FIG. 1 shows a width (d1) of the longitudinal portion of the slit and a width of the extended portion of the slit (d2) in the liquid crystal display device of the present invention.

Regarding the upper limit of the d1, the d1 is, for example, preferably 20 μm or less, more preferably 15 μm or less, and further preferably 10 μm or less. Regarding the lower limit thereof, the d1 is, for example, preferably 3 μm or more.

The preferable ranges of the d2 and the length of the slit extended portion are the same as preferable ranges of the d1 described above. The length of the slit extended portion is the length of the lower side of the slit extended portion in FIG. 1.

The d1, d2, and the length of the slit extended portion may be the same as or different from one another. Thus, the design for providing a desired display quality of the liquid crystal display device of the present invention is easy.

According to a preferable embodiment of the liquid crystal display device of the present invention, a part of the slit along the gate bus line extends to a peripheral end of the pixel electrode.

The expression that a part of the slit extends to a “peripheral end of the pixel electrode” means that a part of the slit is formed so as to reach the peripheral end of the pixel electrode, as shown in FIG. 1.

As a result, the effect of preventing alignment disorder of liquid crystal is particularly excellent.

In the pair of substrates, a preferable embodiment of a substrate (counter substrate) that faces a substrate having the pixel electrode is an embodiment in which the counter substrate includes a common electrode and a rib that extends parallel to a slit when seen in the substrate normal direction of the counter substrate.

The liquid crystal display device of the present invention may be a normally black mode (mode in which the light transmittance or luminance in an off-state is lower than that in an on-state) or a normally white mode (mode in which the light transmittance or luminance in an off-state is higher than that in an on-state). The liquid crystal display device of the present invention may be reflective, transmissive, or semi-transmissive.

Since the liquid crystal display device of the present invention, which can sufficiently respond to finer pixels, is particularly suitably applicable to small- and mid-sized high-definition liquid crystal display devices.

Regarding the upper limit of the pixel pitch in the longitudinal direction of pixels, the pixel pitch is, for example, preferably 200 μm or less, more preferably 190 μm or less, and further preferably 180 μm or less. Regarding the lower limit thereof, the pixel pitch is preferably 50 μm or more, and more preferably 100 μm or more. Regarding the upper limit of the pixel pitch in the direction of shorter sides of pixels, the pixel pitch is preferably 80 μm or less, and more preferably 60 μm or less. Regarding the lower limit thereof, the pixel pitch is preferably 30 μm or more, and more preferably 40 μm or more.

The pixel pitch refers to a length corresponding to one pixel in a pixel sequence, and for example, to a distance between middle points of longer sides of the pixel in the longitudinal direction of the pixel or a distance between middle points of shorter sides of the pixel in the direction of the shorter sides of the pixel.

The aforementioned embodiments may be employed in appropriate combination as long as the combination is not beyond the scope of the present invention.

### Effect of the Invention

The liquid crystal display device according to the present invention uniformly stabilizes the alignment direction of liquid crystal molecules, prevents display roughness and what is called an afterimage phenomenon in which a previous display state remains unchanged in switching display, has excellent display performance, and responds to finer pixels.

### BRIEF DESCRIPTION OF THE DRAWINGS

FIG. 1 is a schematic plan view showing a pixel in a liquid crystal display device according to Embodiment 1.

FIG. 2 is a schematic plan view showing a counter substrate showing a pixel in the liquid crystal display device according to Embodiment 1.

FIG. 3 is a cross-sectional view of the liquid crystal display device according to Embodiment 1.

FIG. 4 is a partially enlarged view showing a pixel of a modified example in the liquid crystal display device according to Embodiment 1.

FIG. 5 is a micrograph showing an alignment state of liquid crystal surrounded by dotted lines in FIG. 1.

FIG. 6 is a schematic plan view showing a pixel in a conventional liquid crystal display device.

FIG. 7 is a micrograph showing an alignment state of liquid crystal surrounded by dotted lines in FIG. 6.

### MODES FOR CARRYING OUT THE INVENTION

The present invention will be mentioned in more detail in the following embodiments, but is not limited to these embodiments.

In the present description, a substrate including a pixel electrode is also referred to as a circuit board. The substrate side is also referred to as a TFT side.

A substrate opposite to the substrate (circuit board) including the pixel electrode is also referred to as a counter substrate. Since the counter substrate is a substrate in which a color filter (CF) is disposed in embodiments, and also referred to as a CF side substrate. The counter substrate side is also referred to as a CF side.

### Embodiment 1

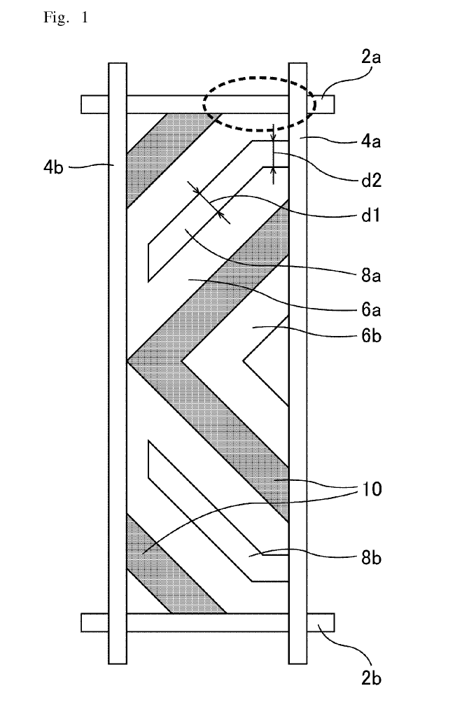

FIG. 1 is a schematic plan view showing a pixel in a liquid crystal display device according to Embodiment 1.

The configuration of the present embodiment is that the liquid crystal display device includes a circuit board (back-side substrate), a counter substrate (observation-side substrate) provided to face the circuit board, and a liquid crystal layer provided to be sandwiched between the circuit board and the counter substrate.

As shown in FIG. 1, slits 8a and 8b are linear electrode slits, and include a linear portion (longitudinal portion) along a rib 10 formed in the counter substrate, and a linear portion (extended portion) that extends in a different direction from an end of the longitudinal portion when seen in the substrate normal direction of the circuit board. The extended portions of the slits 8a and 8b are portions close to gate bus lines in regions including no alignment control projection in a pixel electrode peripheral part, and formed parallel to the gate bus lines 2a and 2b and vertically to source bus lines 4a and 4b. That is, the angle formed by the longitudinal direction of the gate bus line and the longitudinal direction of the slit extended portion is 0°. The longitudinal direction of the extended portions of the slits 8a and 8b differs from the longitudinal direction of the main rib 10, and differs from the longitudinal direction of the longitudinal portions of the slits 8a and 8b. Although not shown, the extended portions of these slits 8a and 8b are formed so as to reach a pixel electrode peripheral end.

The slits 8a and 8b are disposed so as not to be overlapped with the gate bus lines when seen in the substrate normal direction of the circuit board. The distance between the gate bus line and the extended portion of each of the slits 8a and 8b is 5 μm. The slit width d1 of the longitudinal portion and the slit width d2 of the extended portion may be the same as or different from each other. In FIG. 1, the d1 is 9 μm, and the d2 is 9 μm. The length of the longitudinal direction of the slit extended portion (the length of the lower side of the slit extended portion) is 9 μm. This is an embodiment in which a slit smaller than a slit width, and a rib smaller than a rib width, and an auxiliary projection located not along the longitudinal portion of the slit are not provided between the longitudinal portion of the slit and the rib when seen in the substrate normal direction of the circuit board. This eliminates size difficulties in production of a device, and the effects of the present invention can be further sufficiently exerted. In order to form the second rib and a slit between a main projection formed on the counter substrate side and a main slit formed on the circuit board side in the liquid crystal display device in the above-mentioned background art, for example, the pitches of the rib and the slit are usually about half as long as the pitches of only the main rib and the slit. Therefore, the rib on the counter substrate side needs to correspond to the slit on the circuit board side in a tight pitch. Accordingly, the positional relationship must be more strictly regulated in bonding substrates.

In the present embodiment compared with this, since only the shape of the slit formed in the pixel electrode on the circuit board side is changed, it is not necessary to particularly strictly regulate the bond precision to the counter substrate. Therefore, this easily responds to small- and mid-sized high-definition liquid crystals.

In the liquid crystal display device of Embodiment 1, a projection is provided in the counter substrate. As shown in FIG. 1, when seen in the substrate normal direction of the circuit board, the liquid crystal display device includes a region in which a projection and a slit are alternately disposed.

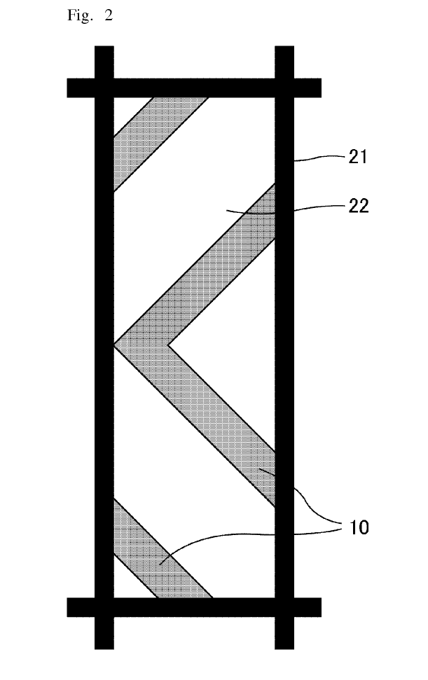

FIG. 2 is a schematic plan view showing a counter substrate showing a pixel in the liquid crystal display device according to Embodiment 1.

As shown in FIG. 2, the liquid crystal display device of Embodiment 1 includes color filters 22R, 22G, and 22B, a black matrix 21, and an alignment control projection 10 on the counter substrate side.

The length of the pixel pitch of the liquid crystal display device of Embodiment 1 in a transverse direction shown in FIGS. 1 and 2 is 54.5 μm, and the length thereof in a longitudinal direction is 163.5 μm.

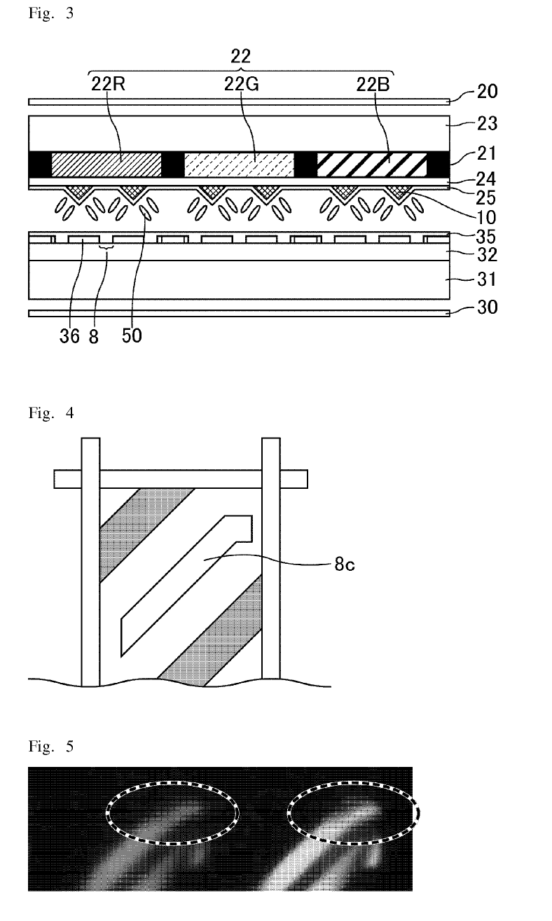

FIG. 3 is a cross-sectional view of the liquid crystal display device according to Embodiment 1.

As shown in FIG. 3, on a counter substrate side, the liquid crystal display device includes color filters 22R, 22G, and 22B and a black matrix 21 on a glass substrate 23, a counter electrode 24 on these, and a liquid crystal alignment control projection 10 on the counter electrode 24. The liquid crystal display device may include an alignment film 25 on the alignment control projection 10.

The circuit board includes pixel electrodes 36 on an insulating layer 32 on a glass substrate 31. The pixel electrodes 36 are equipped with slits 8 (openings) for controlling (p-controlling) the liquid crystal alignment vertically to a substrate surface when no voltage is applied. An alignment film 35 may be provided on these.

In addition, a polarizing plate is disposed on a side opposite to each of the liquid crystal layers of the circuit board and the counter substrate.

Although not shown in the drawings, the circuit board is provided with a thin-film transistor (TFT) that serves as a switching element, and includes an electrode, a storage capacitor wiring, and the like that are electrically connected to the thin-film transistor. The pixel electrode is formed of indium oxide tin (ITO) whose transmission region is made of a transparent electrical conductive material.

The color filter includes red (R), green (G), and blue (B) layers each of which corresponds to the pixel electrodes 36 on the circuit board side. The counter electrode side is formed not in each pixel but as one electrode (common electrode) that corresponds to a plurality of pixels. The counter electrode 24 is formed of ITO.

A polarizing plate 20 is stuck on the observation-side of the glass substrate 23 on the counter substrate side, and a polarizing plate 30 is stuck on the back-side of the glass substrate 31 on the circuit board side. The present embodiment describes an example of a transmissive liquid crystal display device, and the polarizing plate disposed outside the panel may be a linearly polarized mode or a circularly polarized mode.

The display mode of the liquid crystal display device of Embodiment 1 is an MVA mode, and the liquid crystal layer is made of a nematic liquid crystal with negative permittivity anisotropy. The pixel is divided by linear ribs and slits which are provided on the substrate. Liquid crystal molecules 50 in the liquid crystal layer are aligned substantially vertically in a state of no voltage application (in an OFF state), and are inclined substantially horizontally in multiple directions divided by the linear ribs and slits in a state of voltage application (in an ON state). Thereby, a wide viewing angle can be achieved.

FIG. 4 is a partially enlarged view showing a pixel of a modified example in the liquid crystal display device according to Embodiment 1.

The modified example of Embodiment 1 may be an example in which, as shown in FIG. 4, the tip of a slit 8c that has been bent parallel to the longitudinal direction of the gate bus line does not reach a pixel electrode edge. Except for that, the modified example has the same configuration as Embodiment 1.

As a result, a certain effect of preventing the alignment disorder of liquid crystal is achieved, and pixel design requirements can be satisfied in the case where a slit tip cannot be formed so as to reach a pixel electrode edge, such as a case where a bridge portion of the pixel electrode needs to remain.

It is to be noted that, as shown in FIG. 1, the effect of preventing the alignment disorder of liquid crystal is larger in the case where the slit is formed so as to reach the electrode edge.

The micrographs that show enlarged portions of pixels close to the gate bus lines are compared in the liquid crystal display device according to Embodiment 1 and a conventional liquid crystal display device.

FIG. 5 is a micrograph showing an alignment state of liquid crystal surrounded by dotted lines in FIG. 1.

FIG. 6 is a schematic plan view showing a pixel in a conventional liquid crystal display device.

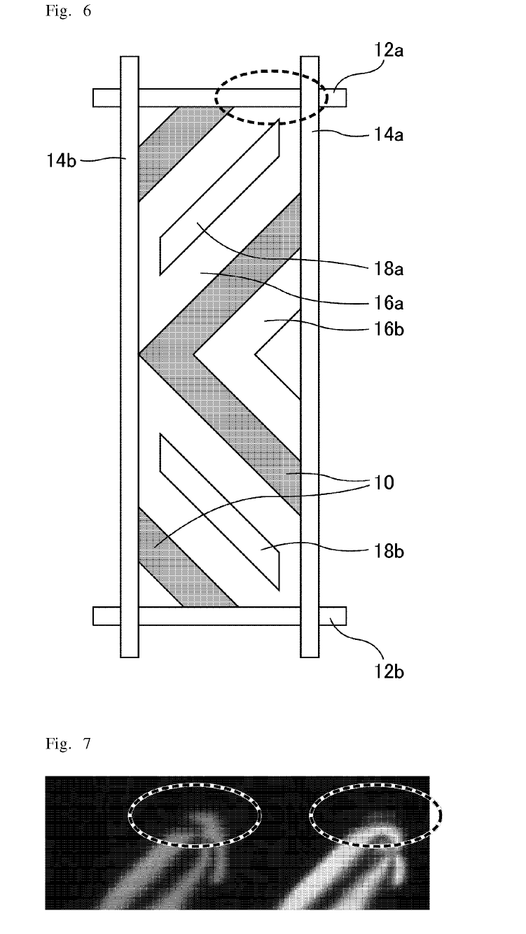

FIG. 7 is a micrograph showing an alignment state of liquid crystal surrounded by dotted lines in FIG. 6.

The micrographs shown in FIG. 5 and FIG. 7 show that adjacent two pixels in a white display state are observed in transmitted light under a microscope with a polarizing plate disposed in a cross-Nicol state.

FIG. 1 that shows a pixel of the liquid crystal display device according to Embodiment 1 and FIG. 6 that shows a pixel of a conventional liquid crystal display device will be described hereinafter.

The parts surrounded by dotted lines in FIG. 1 and FIG. 6 are each a portion of a pixel of the liquid crystal panel in the vicinity of the gate bus line. The parts surrounded by dotted lines in FIG. 5 and FIG. 7 are each the portion of adjacent two pixels (a red pixel on the left-hand side and a green pixel on the right-hand side).

The parts surrounded by circles of dotted lines on the left-hand side (red) and the right-hand side (green) in FIG. 5 and FIG. 7 include black lines.

The shape of the black lines changes based on the relationship between the axial direction of a polarizing plate and the alignment direction of liquid crystal molecules. In FIG. 7 showing a conventional liquid crystal display device, portions along the gate bus line in adjacent pixels have different alignment directions (states) of liquid crystal molecules. In contrast, in FIG. 5 that indicates the liquid crystal display device of Embodiment 1 shows that the shapes of black lines are the same as each other on a left-hand side (red) pixel and a right-hand side (green) pixel, and the alignment direction of liquid crystal molecules are uniform.

The axial direction of the polarizing plate is constantly observed. The black portion that extends at an angle of 45° in the middle of a bright portion is a slit portion, and liquid crystal remains aligned vertically and therefore looks black.

The degree of occurrence of display afterimages was observed using the liquid crystal display device according to Embodiment 1 and a conventional liquid crystal display device. The following describes the results.

### (1) Experiment Description

The occurrence of afterimages was visually observed in the case where lines were displayed in white vertically and horizontally against the background of a black display, and thereafter the full screen was displayed in white.

### (2) Results

In the conventional liquid crystal display device shown in the following table, the period of time until afterimages disappear increases as the white-side voltage rises. In contrast, in the liquid crystal display device according to Embodiment 1, no afterimage occurs even at a high voltage. In the following table, the number of seconds (s) represents a period of time until afterimages disappear. “None” means no afterimage.

TABLE 1

| | | White line display voltage | | | | | | |
|---|---|---|---|---|---|---|---|---|
| | | 6.2 V | 6.3 V | 6.4 V | 6.5 V | 6.6 V | 6.7 V | 6.8 V |
| Time until | Embodiment 1 | None | None | None | None | None | None | None |
| afterimages | Conventional | None | 1 s | 2 s | 3 s | 3 s | 4 s | 5 s |
| disappear | example | | | | | | | |

The above results show that the alignment direction of liquid crystal in a region along the gate bus line is kept uniform, whereby an afterimage phenomenon in switching display can be suppressed.

In the liquid crystal display device of the present embodiment, a rib smaller than a rib width, and an auxiliary projection located not along the longitudinal portion of the slit are not provided between the longitudinal portion of the slit and the rib when seen in the substrate normal direction of the circuit board, leading to improvement in an aperture ratio.

The modes of the aforementioned embodiments may be employed in appropriate combination as long as the combination is not beyond the scope of the present invention.

The present application claims priority to Patent Application No. 2009-239717 filed in Japan on Oct. 16, 2009 under the Paris Convention and provisions of national law in a designated State, the entire contents of which are hereby incorporated by reference.

### EXPLANATION OF NUMERALS AND SYMBOLS

2a, 2b, 12a, 12b: Gate bus line
4a, 4b, 14a, 14b: Source bus line
6a, 6b, 16a, 16b, 36: Pixel electrode
8, 8a, 8b, 8c: Slit
10: Alignment control projection
20, 30: Polarizing plate
21: Black matrix
22: Color filter
22R: Red color filter
22G: Green color filter
22B: Blue color filter
23, 31: Glass substrate
24: Counter electrode
25, 35: Alignment film
32: Insulating layer
d1: Width of longitudinal portion of slit
d2: Width of extended portion of slit

1. A liquid crystal display device, comprising:
a pair of substrates; and
a liquid crystal layer sealed between the pair of substrates,
wherein the liquid crystal layer contains liquid crystal molecules that are aligned vertically to a substrate surface when no voltage is applied,
at least one of the pair of substrates includes a pixel electrode, a gate bus line, and a source bus line,
the pixel electrode is provided with a slit,
the slit bends, and
a part of the slit is along the gate bus line.

2. The liquid crystal display device according to claim 1,
wherein the slit has a longitudinal portion and an extended portion that extends from an end of the longitudinal portion to a different direction, and the extended portion is along the gate bus line.

3. The liquid crystal display device according to claim 1,
wherein a part of the slit along the gate bus line extends to a peripheral end of the pixel electrode.
